(19) United States
(12) Patent Application Publication
(10) Pub. No.: US 2010/0213724 A1
(43) Pub. Date: Aug. 26, 2010

(54) Multiple point door locking system, with handle turning direction control

(75) Inventor: Alan K. Uyeda, Irvine, CA (US)

Correspondence Address: WILLIAM W. HAEFLIGER, 201 S. LAKE AVE, SUITE 512, PASADENA, CA, 91101, US

(73) Assignee: ADAM RITE MANUFACTURING CO.

(21) Appl. No.: 12/384,948

(22) Filed: Apr. 10, 2009

Related U.S. Application Data
(63) Continuation-in-part of application No. 12/393,140, filed on Feb. 26, 2009.

(51) Int. Cl. E05C 9/12; E05B 65/06; E05B 13/10

(52) U.S. Cl. 292/39; 70/134; 70/209

(57) ABSTRACT

A multi-function door lock system, comprising in combination, a frame having opposite sides, and installable on a door openable between an interior space and an exterior space, a deadbolt and a door latch carried by the frame to move between retracted and extended positions, a first rotary control located at one level on the frame to control deadbolt movement between extended and retracted positions via primary cam mechanism, a second rotary control at another level on the frame to control latch movement between extended and retracted positions, via secondary cam mechanism, means operatively connected between said secondary cam mechanism and the primary cam mechanism to effect deadbolt movement as aforesaid, in response to operation of the second rotary control, as effected via rotary input to the second rotary control from only one side of the frame. Means is also provided to be responsive to reverse rotation of the first rotary control to effect latch retraction independently of deadbolt displacement.

### BACKGROUND OF THE INVENTION

This invention relates generally to controlling the locking and unlocking of doors; and more particularly concerns provision of highly compact and improved mechanism for enabling operating of latches and deadbolts, as from opposite sides of doors.

There is need for simple, highly compact, durable and efficient door locking and unlocking devices, where deadbolts and latches are to be operated, as from the inner and outer sides of doors. In particular, there is need for improvements in mechanism responsive to door handle turning, at the door inner side, with mechanism responsive to door unlocking at the door inner side, to secure both deadbolt release and door unlatching.

### SUMMARY OF THE INVENTION

It is a major object of the invention to provide improvements on apparatus meeting the above needs. Basically, and in accordance with the invention, a multi-function door lock system is provided, comprising:

a) a frame having opposite sides, and installable on a door openable between an interior space and an exterior space,

b) a deadbolt and a door latch carried by the frame to move between retractable and extended positions,

c) a first rotary control located at one level on the frame to control deadbolt movement between extended and retracted positions via primary cam mechanism,

d) a second rotary control at another level on the frame to control latch movement between extended and retracted positions, via secondary cam mechanism,

e) means operatively connected between said secondary cam mechanism and said primary cam mechanism to effect deadbolt movement as aforesaid, in response to operation of the second rotary control, as effected via rotary input to the second rotary control from only one side of the frame.

As will be seen, and in a preferred form of the invention, the above e) means includes a strut or link provided to extend between the secondary and primary cam mechanisms and bodily movable in response to the rotary input to said second rotary control.

Another object includes provision of the first rotary control to have input means presented at opposite sides of the frame for effecting operation of the first rotary control from either side of the door to which the frame is installed; and provision of the second rotary control to have input means presented at opposite sides of the frame, for effecting operation of the second rotary control from either side of the door to which the frame is installed.

Typically, finger and thumb operated rotors are provided at opposite sides of the frame, corresponding to opposite sides of a door carrying the frame, and are connected with the first rotary control for controlling deadbolt positioning. Also, and typically, handle levers are provided for operation at opposite sides of the frame, to be connected with the second rotary control, for controlling latch positioning. In this environment, only the lever at the inner side of the frame, and door, release both the deadbolt and door latch in response to turning of that lever.

Yet another object is to provide split-cam means to operate in conjunction with operation of the first rotary control. And a further object is to provide second split-cam means to operate in conjunction with operation of the second rotary control and displacement of the strut.

A further object includes provision of a selector means whereby turning of the handle at the door exterior optionally effects latch retraction and deadbolt retraction, simultaneously.

An added object is to provide a deadbolt actuating lever, and two cam followers associated with the lever to be displaced in opposite rotary directions, respectively, to displace the deadbolt between extended and retracted positions, and in response to operation of a primary cam defined by said primary cam mechanism.

An additional object is to provide a link having operative connection to said lever to displace the actuating lever in a rotary direction to effect extension of the deadbolt, in response to said rotary input to said second rotary control.

A further object includes provision of means responsive to reverse rotation of the first rotary control to effect latch retraction independently of deadbolt displacement.

These and other objects and advantages of the invention, as well as the details of an illustrative embodiment, will be more fully understood from the following specification and drawings, in which:

### DRAWING DESCRIPTION

FIG. 1 is an elevation showing a door edge with two inputs (latch key and handle) from the door extension side, and two inputs (finger and thumb, knob and door handle) from the door interior side;

FIG. 2 is an elevation taken on lines 2-2 of FIG. 1;

FIG. 3 is an elevation taken on lines 3-3 of FIG. 1;

FIG. 4 is a vertical section taken on lines 4-4 of FIG. 2;

FIG. 5 is an elevation taken on lines 5-5 of FIG. 4 and showing the frame and actuating mechanism within the frame, as viewed from the door interior side; both deadbolt and latch elements extended;

FIG. 6 is an elevation taken on lines 6-6 of FIG. 4; and showing both deadbolt and latch elements extended into openings in a door frame; and as viewed from the door exterior side;

FIG. 7 is a view like FIG. 5, but showing the deadbolt retracted, and latch extended;

FIG. 8 is a view like FIG. 6, but showing the deadbolt retracted and latch extended;

FIG. 9 is a view like FIG. 8 but showing both the deadbolt and latch retracted, whereby the door can freely swing between locations at opposite sides of the door frame;

FIG. 10 is a view like FIG. 5, but showing locked positions of different actuator elements;

FIG. 11 is a view like FIG. 6, but showing locked positions of different actuator elements;

FIG. 12 is a view like FIG. 10 but showing unlocked positions of the elements seen in FIG. 10;

FIG. 13 is a view like FIG. 11 but showing unlocked positions of the elements seen in FIG. 11;

FIG. 14 is a fragmentary section taken on lines 14-14 of FIG. 10;

FIG. 15 is a fragmentary section taken on lines 15-15 of FIG. 12;

FIG. 16 is a fragmentary section, like FIG. 15, but viewing the frame with extended and interior sides reversed;

FIG. 17 is a perspective view of an actuator arm seen in FIGS. 12 and 13;

FIG. 18 is a section showing holdback mechanism in engaged position; with latch bolt in extended position;

FIG. 19 is like FIG. 18 but shows the holdback mechanism in sidewardly disengaged position, with the latch bolt in retracted position;

FIG. 20 is like FIG. 19, but with a hold back plate displaced downwardly into a groove in the retracted latch;

FIG. 21 is an exploded view of the latch plate, the latch bolt; and the hold back plate retainer;

FIG. 22 is a view like FIG. 5, but showing split cam structure, the deadbolt being in locked extended position, and the latch also being extended.

FIG. 23 is an enlarged section taken on lines 23-23 of FIG. 22;

FIG. 24 is a view like FIG. 6, and showing split cam mechanism in deadbolt extended and locked position, with a deadlock arm in actuated position;

FIG. 25 is a view like FIG. 24, showing the deadlock arm moved away from the deadbolt to allow deadbolt release;

FIG. 26 is a view like FIG. 25, showing elements when deadbolt and latch are retracted;

FIG. 27 is a section taken on line 27-27 of FIG. 24, elements being locked;

FIG. 28 is a view like FIG. 27, showing elements in unlocked positions;

FIG. 29 is a plan view section taken on lines 29-29 of FIG. 24, elements being locked;

FIG. 30 is a section taken on lines 30-30 of FIG. 29;

FIG. 31 is an exploded perspective view showing split cam mechanism;

FIG. 32 is a perspective view of mechanism elements; and

FIG. 33 is a view similar to FIG. 32, but showing additional elements.

### DETAILED DESCRIPTION

In the drawings, a preferred multi-function door lock system or apparatus 10, has a mounting frame 11 sized for insertion into a door opening 11′.

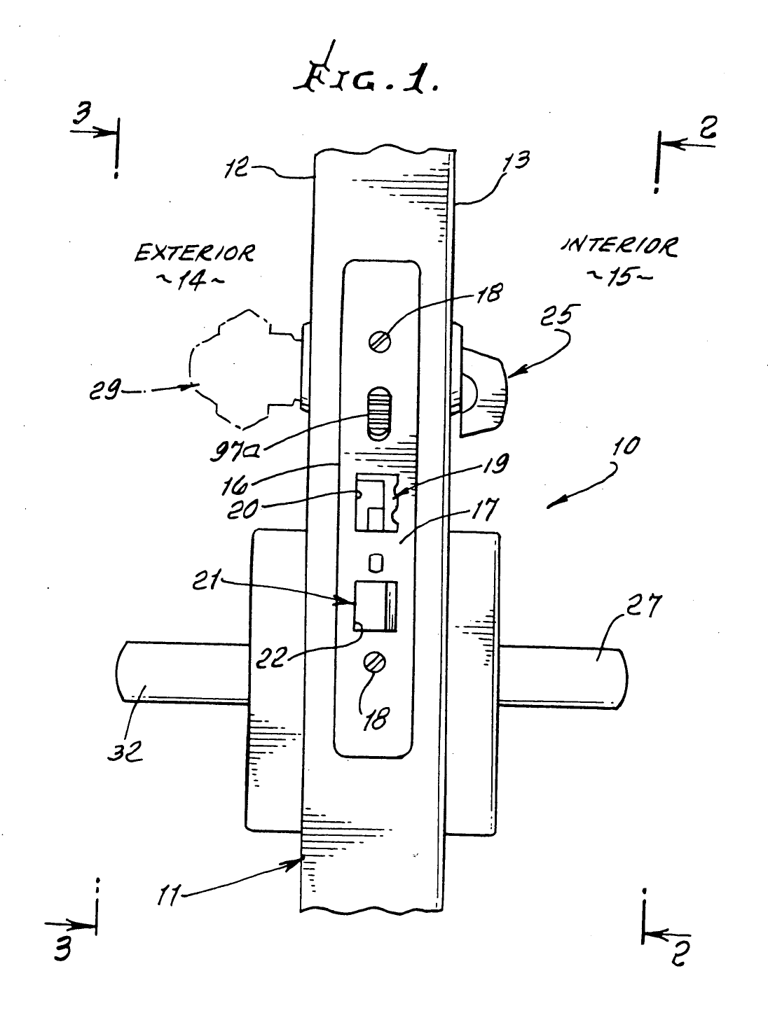

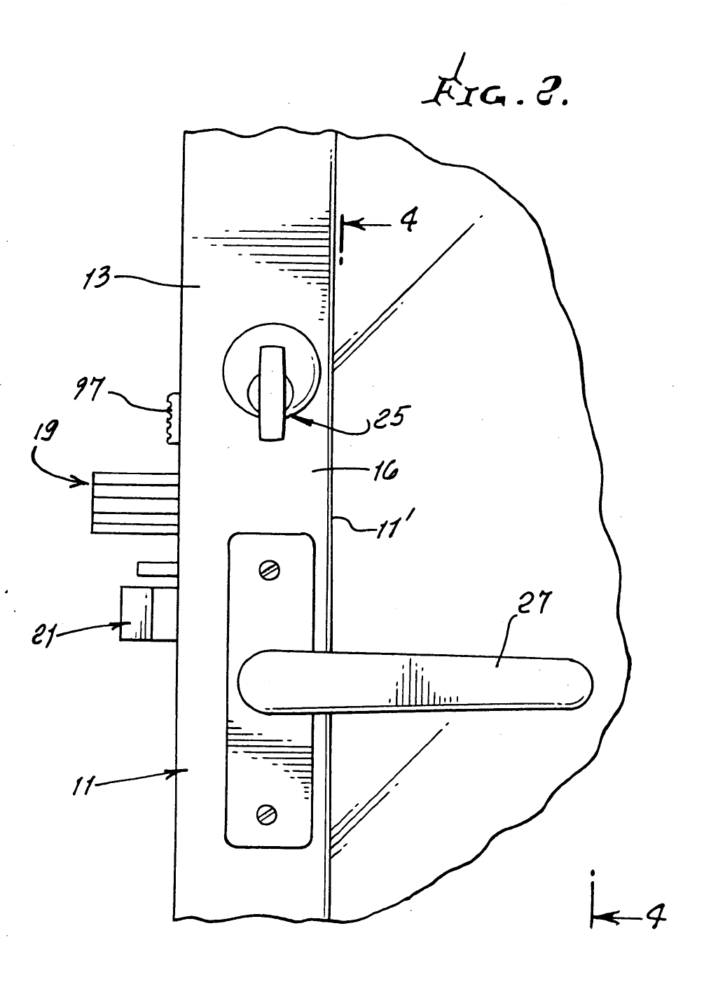

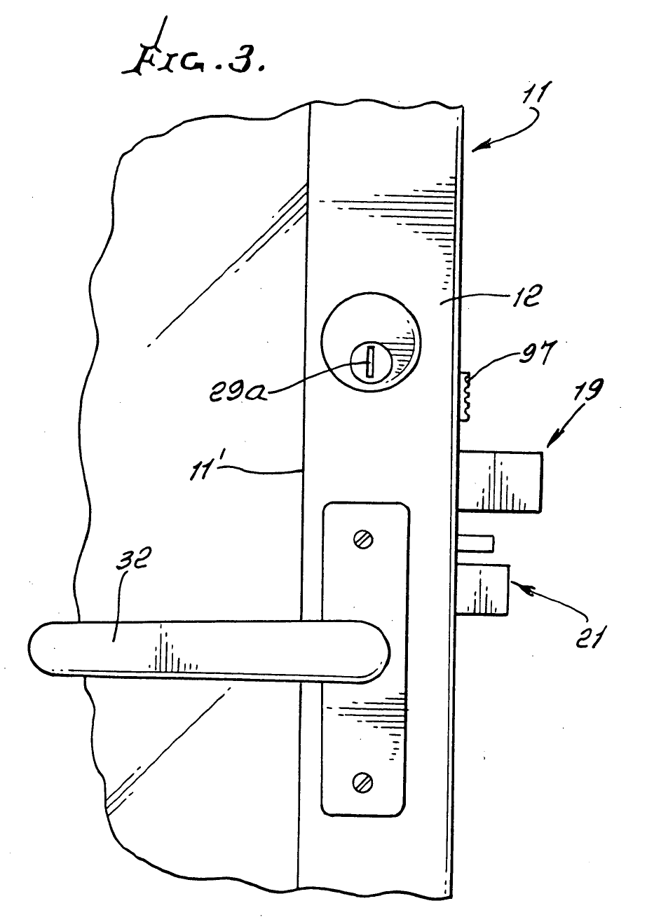

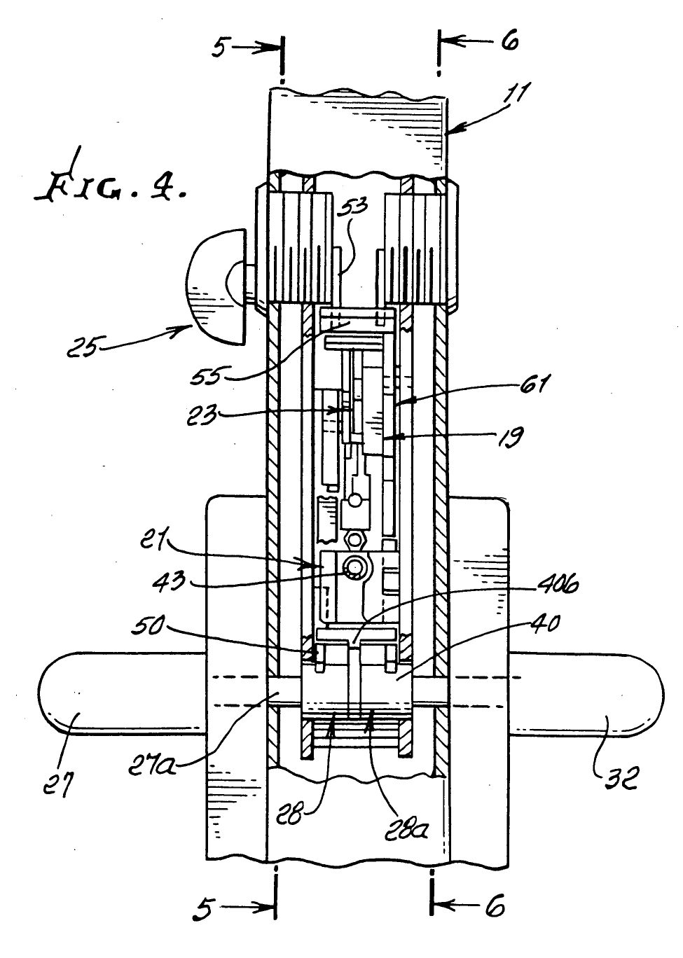

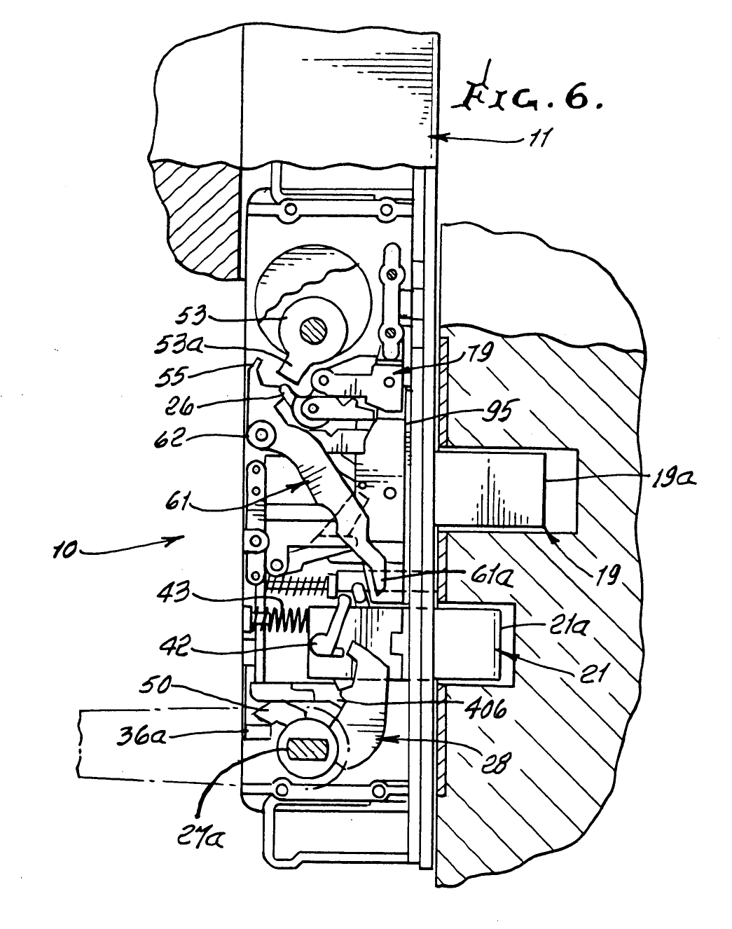

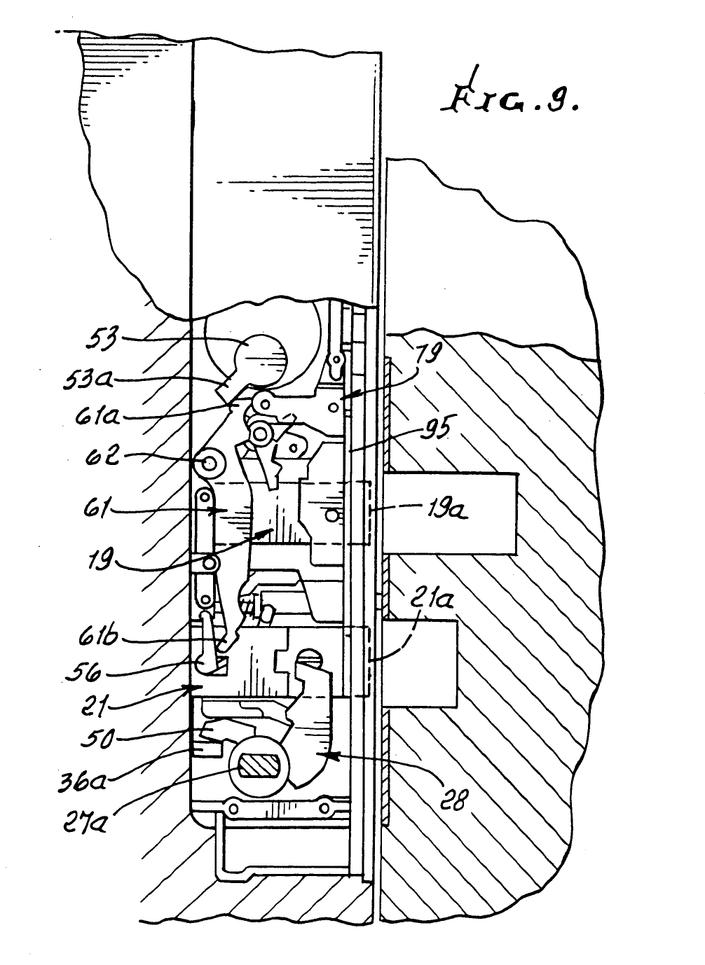

The frame has opposite sides 12 and 13 which respectively face toward the door exterior 14, and the door interior 15. The front side 16 of the frame is carried by a mounting plate 17 held in position by fasteners 18, as seen in FIG. 1. As also seen in FIG. 2, a deadbolt 19 is carried by the frame to protrude from the plate 17, via opening 20, as the bolt is moved between extended position 19a (see FIG. 6) and retracted position 19b in the frame (see FIG. 7); and a latch bolt or latch 21 is carried by the frame to protrude from plate 17 via opening 22, as it is moved between extended position 21a and retracted position in the frame. Elongated frame structure appears at 11a-11d. See FIGS. 10 and 11.

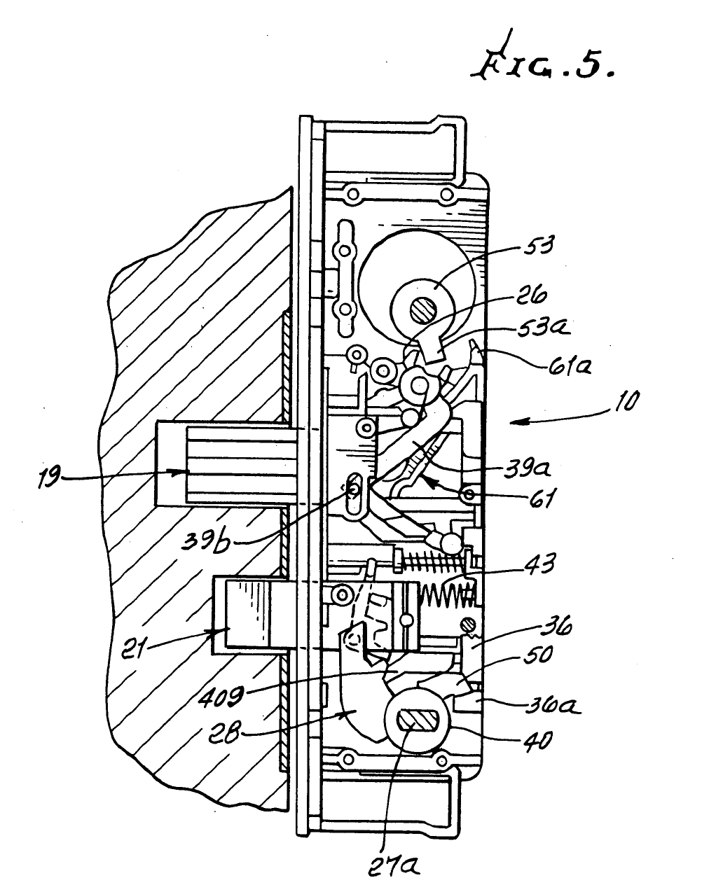

A first rotary control such as rotary actuator 25 is located at one level on the frame, at the interior side of the door, for example, to control deadbolt movement between extended and retracted positions via compact mechanism in the frame. That mechanism typically includes primary cam 26. Actuator 25 is typically gripped by the user's thumb and finger, to be turned in operating the deadbolt. A second rotary control, such as handle 27 is located at a second and typically lower level, to project from the frame, at the interior side of the door, for example, to control latch 21 movement between extended and retracted positions via compact mechanism in the frame, that mechanism typically including secondary cam mechanism 28. See FIG. 5.

FIG. 1 also shows a key 29 projecting or inserted via keyhole 29a at the exterior side of the door, i.e. opposite from rotary actuator 25, to be operatively connected with the first rotary control for moving the deadbolt (as between extended or locking positions, and a retracted or unlocking position). Also FIG. 1 shows a second handle or handle lever 32, projecting at the exterior side of the door, and at the opposite side of the frame from handle 27. Handle 32 is operatively connected with the second rotary control mechanism as is handle 27 to control latch movement between extended and retracted positions, in response to manual down-turning of handle 32, at the exterior side of the door.

Latch movement between extended and retracted positions occurs in response to turning of either of handles 27 and 32 as effected via compact secondary cam mechanism 28.

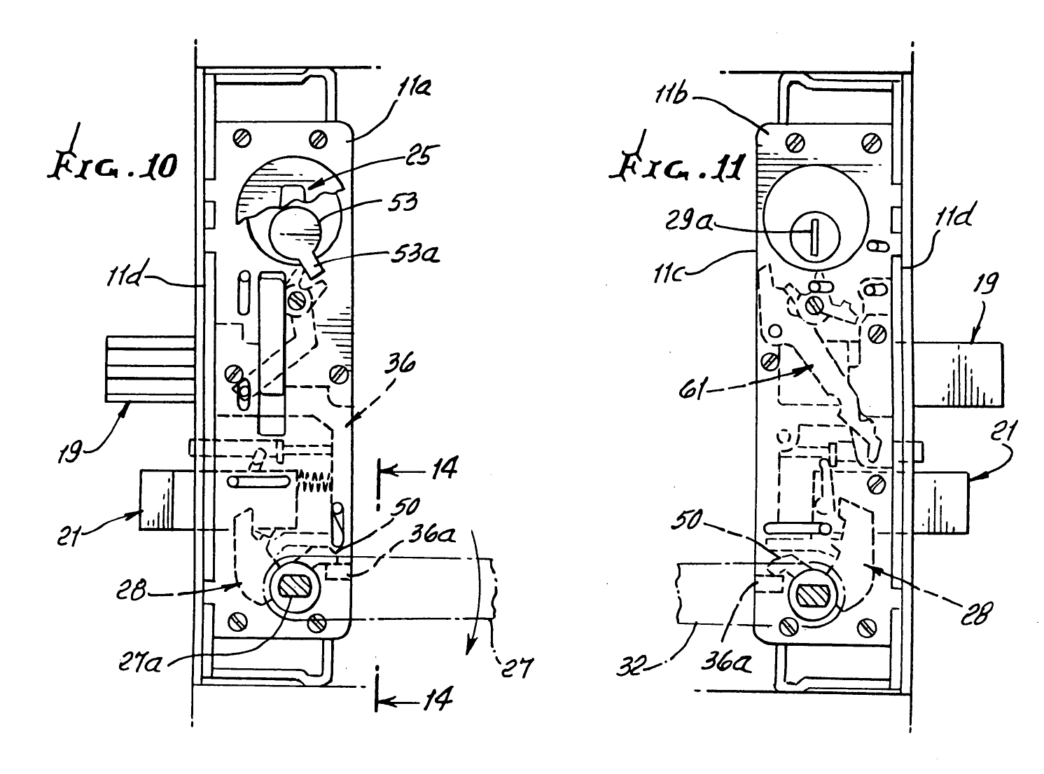

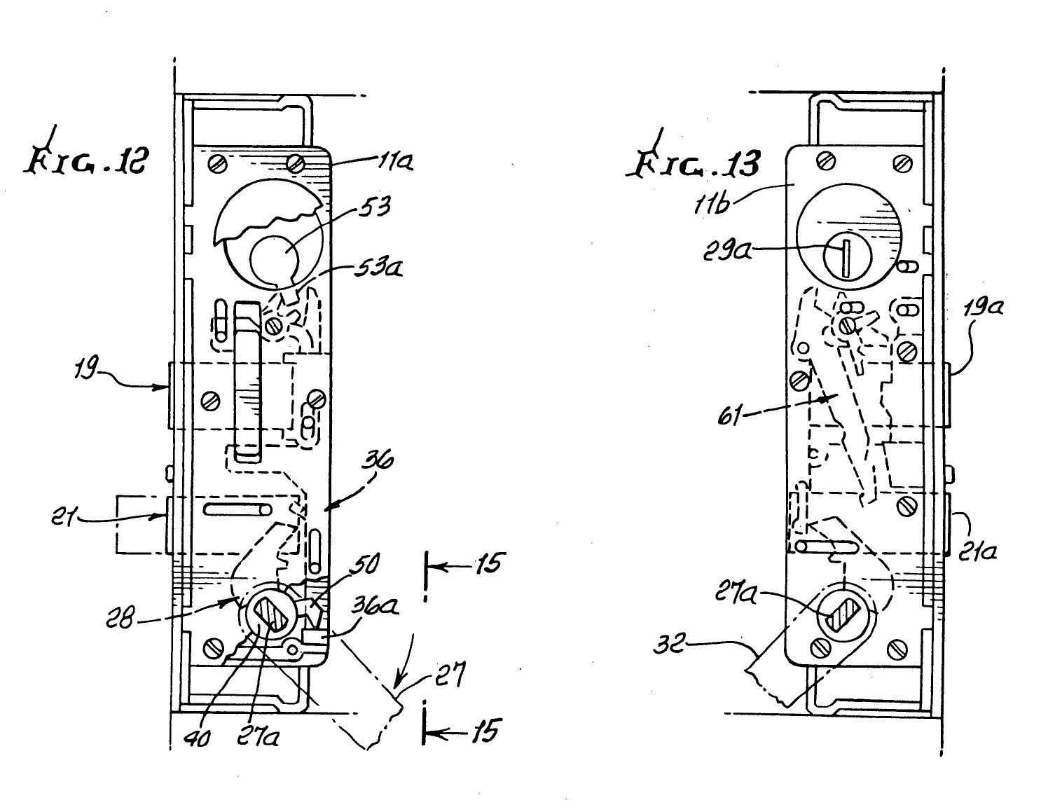

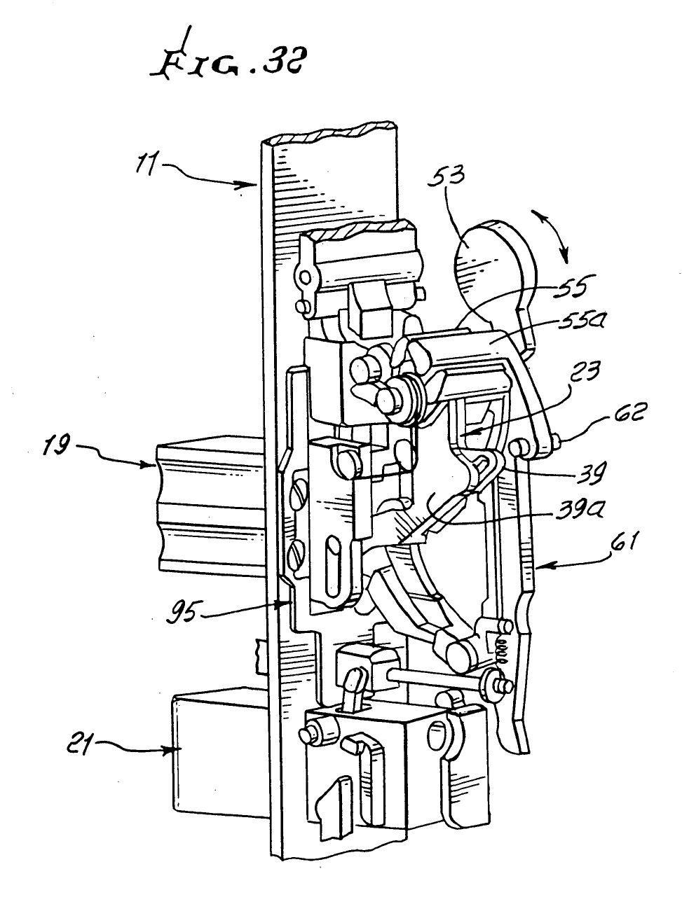

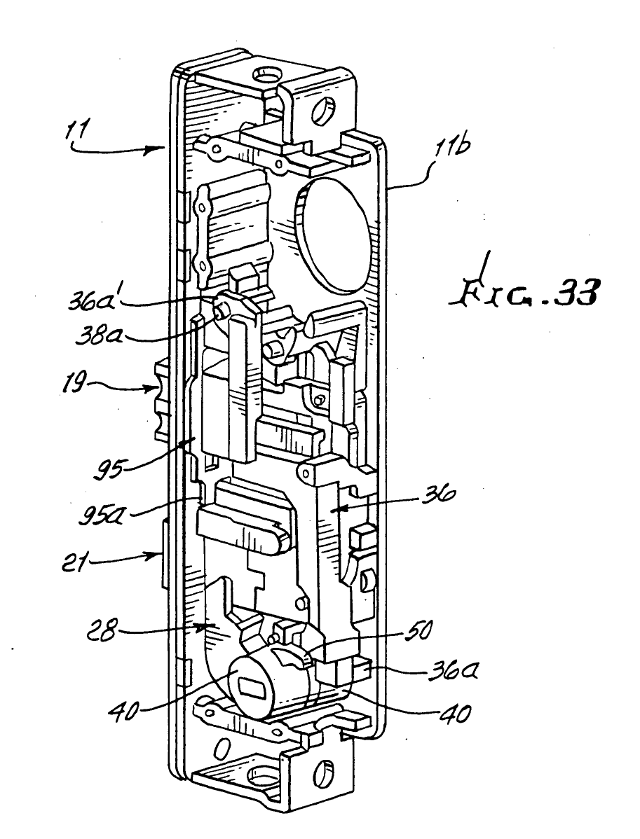

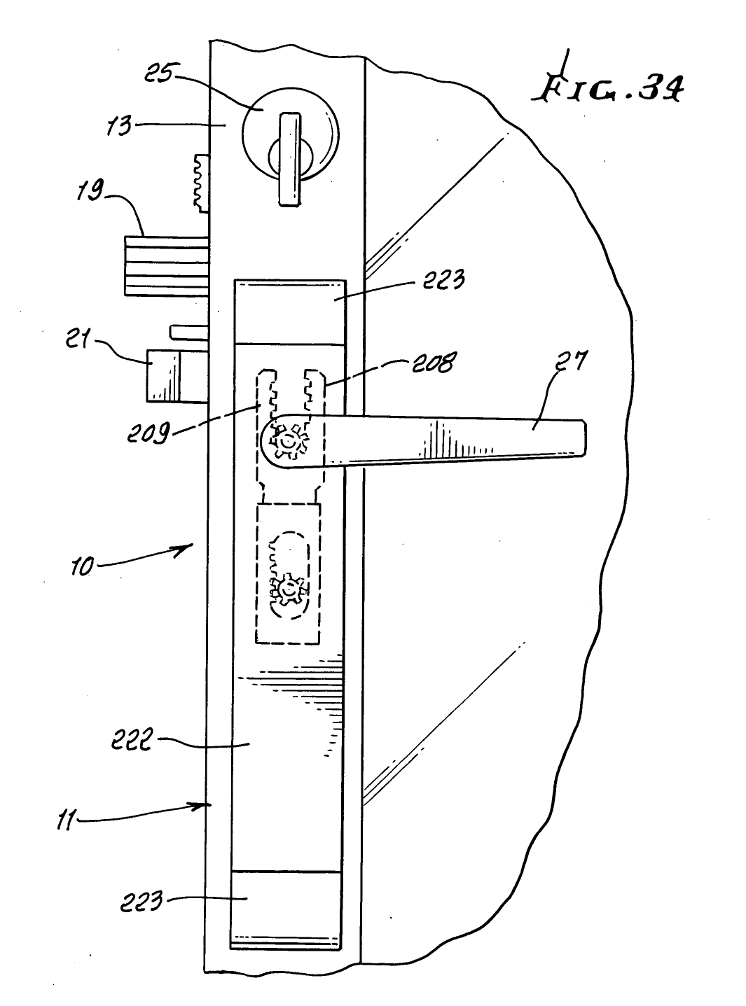

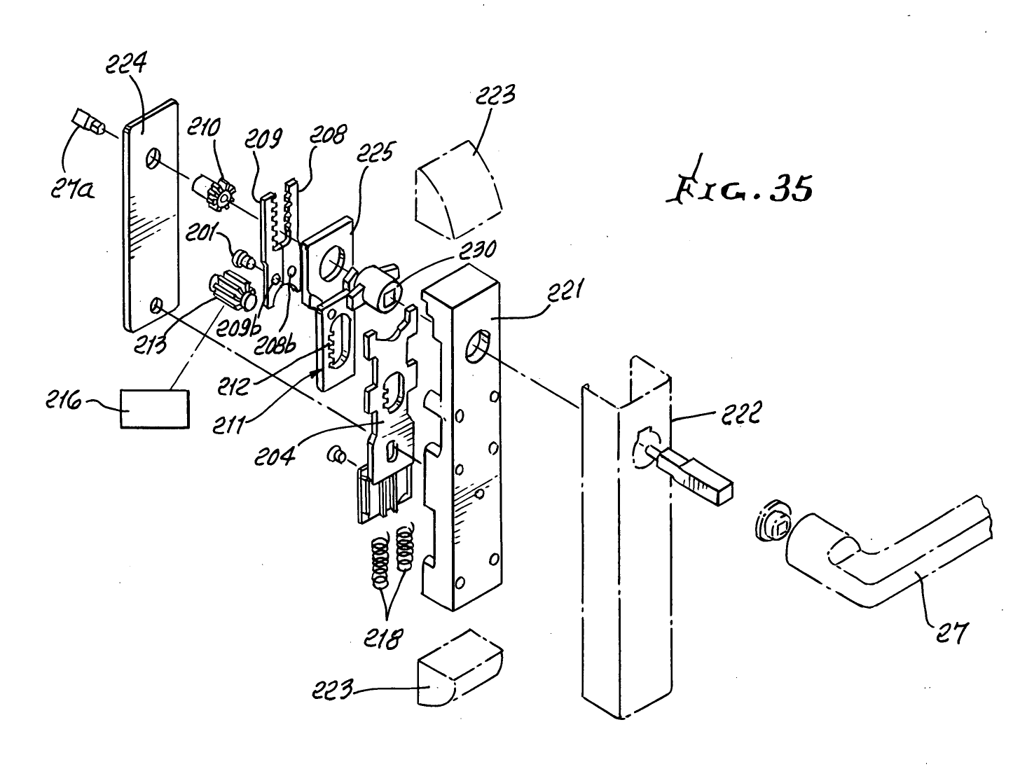

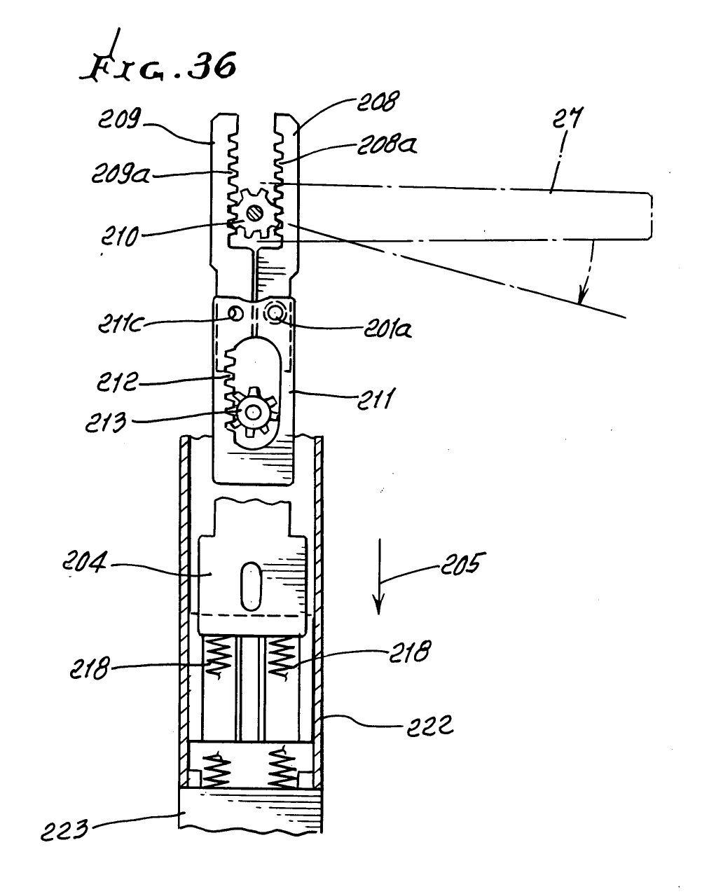

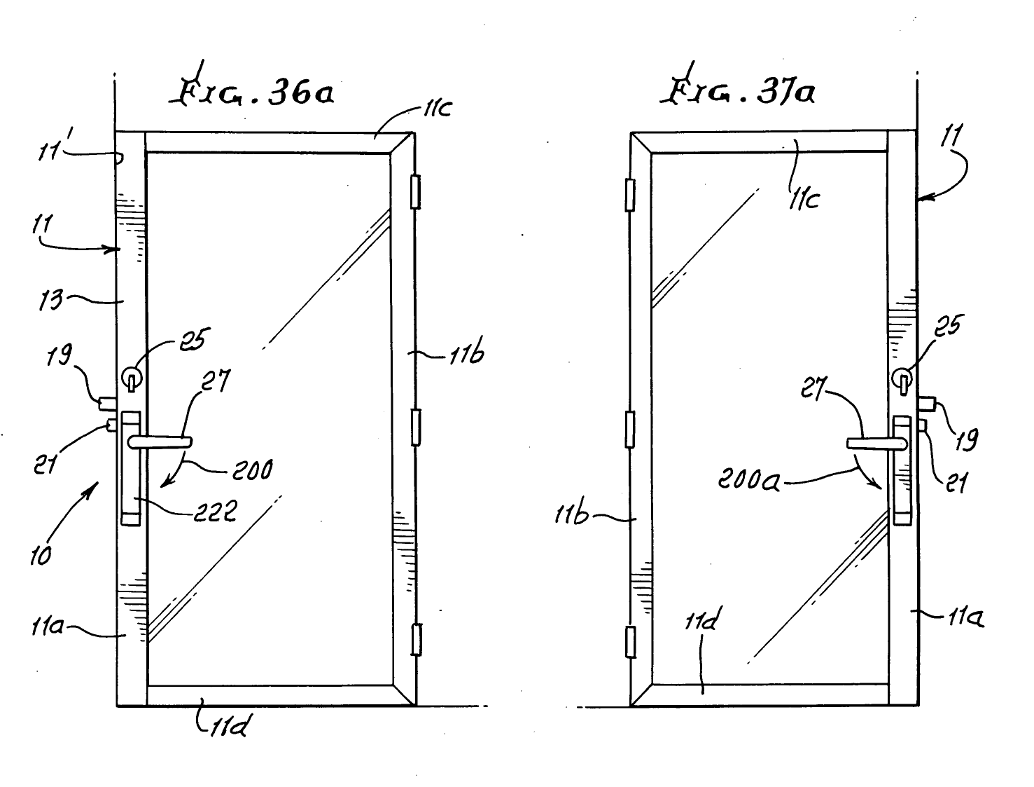

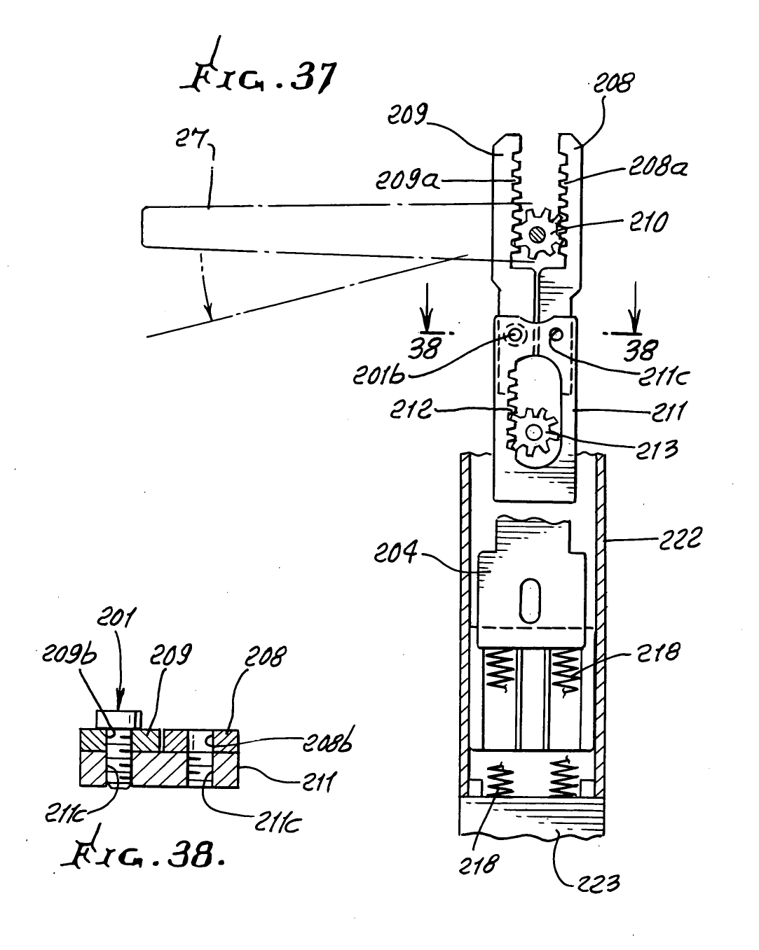

It is a feature of the invention that means is provided and operatively connected between the secondary cam mechanism 28 and primary cam mechanism 26 to effect deadbolt movement as aforesaid in response to operation of said second rotary control, as effected via rotary input to said second rotary control from only one side of the frame. Thus, for example, as interior side handle 27 is turned to turn shaft 27a, not only is the latch retracted from extended position in engagement with the door frame or associated hardware, at opening 22, (see FIGS. 12 and 13) but also the deadbolt is retracted from extended position in engagement with the door frame or associated hardware, whereby a person trapped at the door interior side (building room side) can quickly escape from that interior by opening the deadbolt locked and latch engaged door in response to emergency turning of handle 27 alone; this occurs even though actuators at 25 and 29 are not manipulated. This is enabled by provision and operation of lower split cam mechanism 28 effecting downward translation of a link 36 (see FIG. 12) which extends upwardly into operative engagement or connection with compact upper or primary split cam mechanism 23, (see FIG. 22) and which in turn effects deadbolt retraction from locking or extended positions. In this regard, as the secondary split cam mechanism is operated by handle 27, the latch is retracted from engagement with the door frame or associated hardware. As a result, the door is completely unlocked, i.e. is free for swinging to allow “panic” escape. See in this regard lower split cam mechanism arm 50 in FIGS. 12 and 25, rotating into engagement with foot 36a of link 36 to displace 36 downwardly, as in FIG. 25. This causes or effects downward movement of arm extension 36a′, pin guided at 36c, to push pin 38a down to engage arm 38, rotating it and actuating arm 39 clockwise in FIG. 25. This causes downward and leftward movement of actuating arm 39, of the upper split cam (see also FIG. 31), so that a pin 39b extending in deadbolt slot 49 retracts the deadbolt due to pin 39b movement to the left, in vertical lost motion slot 49 in the deadbolt 19, retracting the deadbolt to the left, in FIG. 26. Arms 39 and 39a of the upper split cam extend from hubs 39′ and 39a′, in FIG. 31. The arms are assembled side by side. See FIG. 30.

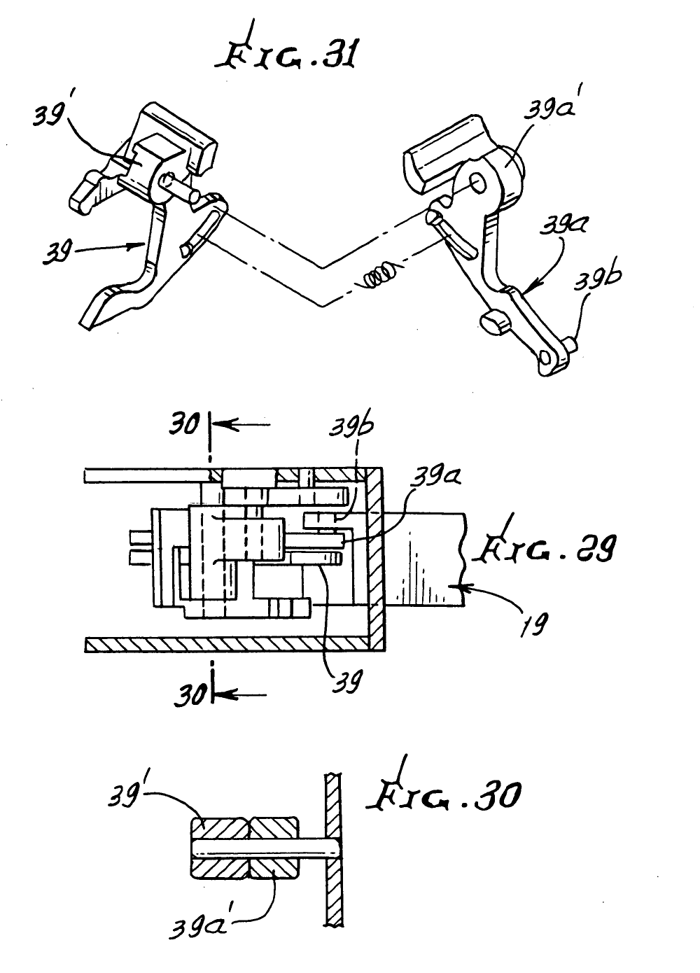

In this regard, return of the deadbolt to the right in FIG. 24 is effected by rotation of key 29 or by actuator 25, rotating the rotor 53 clockwise in FIG. 24. A dog 53a on 53 then cams or rotates the upper split cam part 55 counterclockwise, which rotates 39 counterclockwise, pushing the deadbolt to the right, via pin 39a movement in slot 49. Rotation of rotor 53 counterclockwise by the key causes lug 53a to push cam part 55a and cam 39 clockwise to retract the deadbolt.

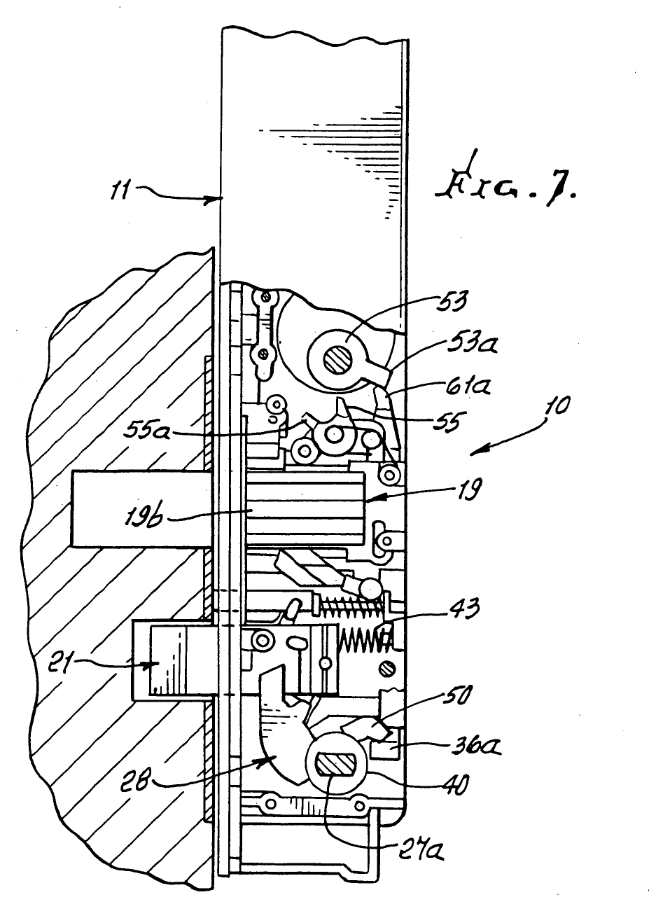

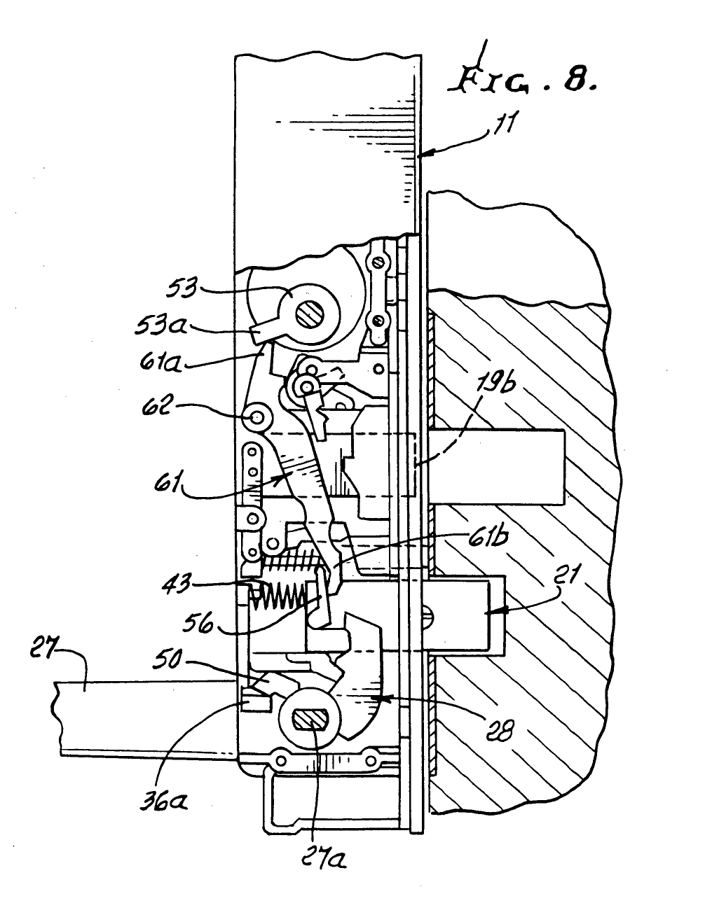

FIGS. 8 and 9 also show mechanism to retract the latch 21 in response to reverse (counter-clockwise) rotation of rotor 53 by either of 25 or 29, seen in FIG. 1. As shown, dog or lug 53a on rotor 53 (rotated counterclockwise) engages projection 61a on or lever 61, pivoted at 62, to rotate 61 counterclockwise. Lower extension 61b on 61 then engages part 56 associated with the secondary cam mechanism to retract the latch. That mechanism includes a split hub 40 and camming part 28 which rotates clockwise in FIGS. 5 and 12 to engage and displace lug 42 on the latch body 21a, (FIG. 6) retracting the latch to the right in FIG. 5, against compression spring 43.

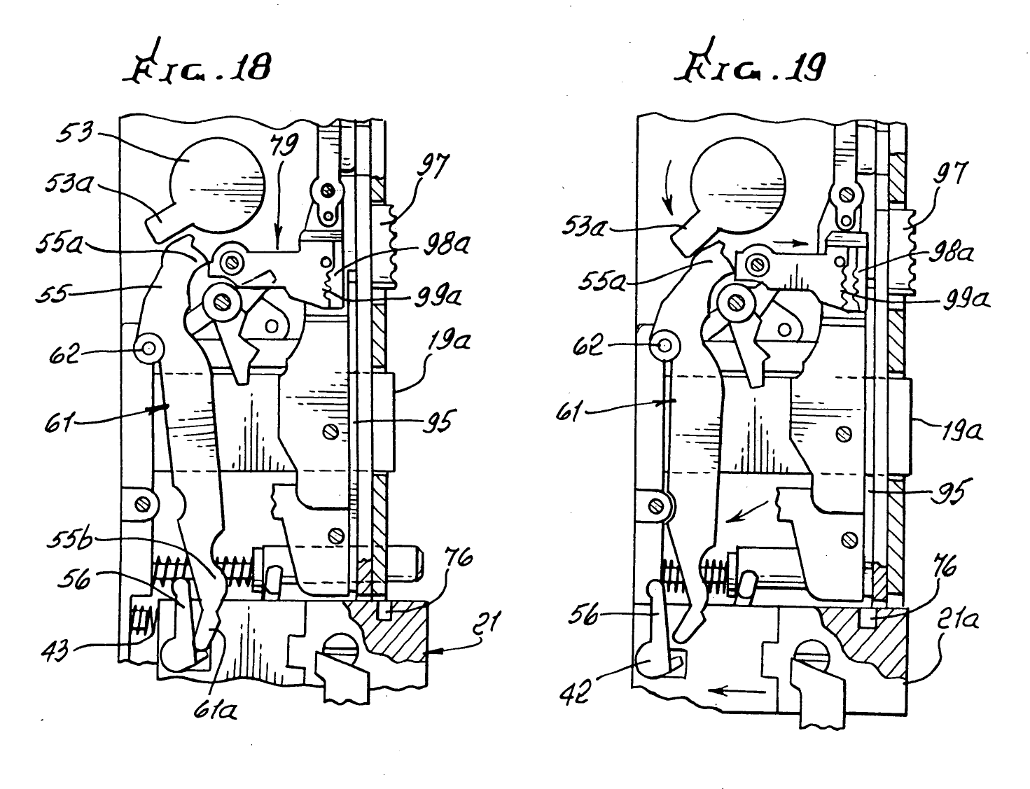

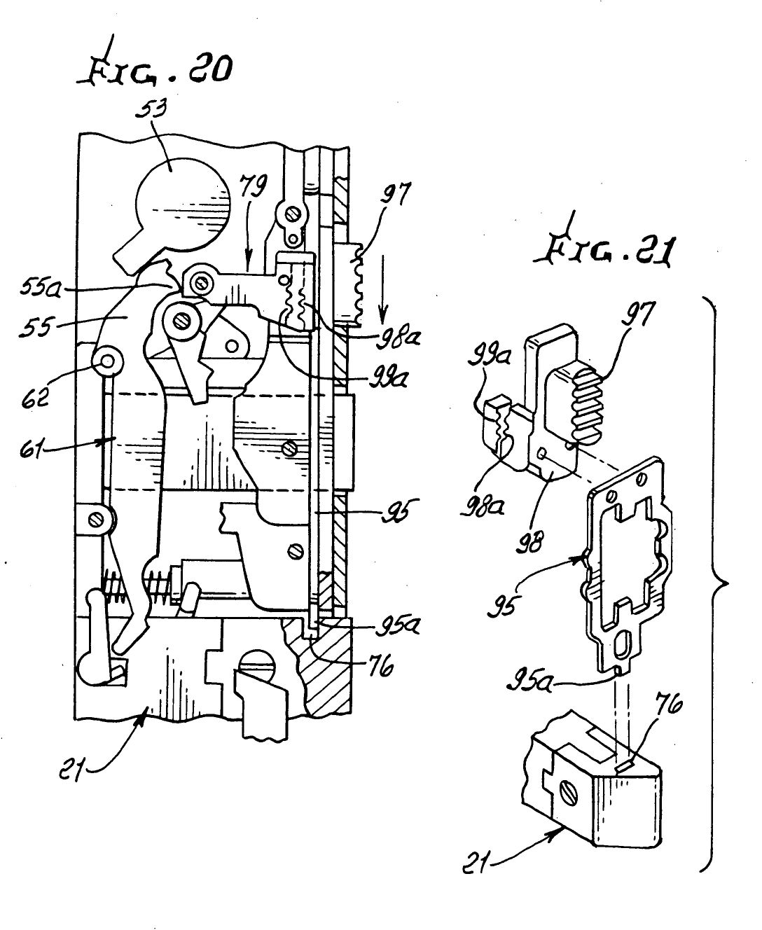

Arm 50 on the hub 40 is rotatable to displace lug 36a on link 36 downwardly. This movement causes downward translation of link 36 (see FIGS. 12-17 and 26) effecting or enabling retraction of the deadbolt, via operation of the primary cam mechanism, as referred to. Part 406 in FIGS. 5 and 6 does not dog 28 but is axially spaced between 28 and 28a.

In this regard, counterclockwise turning of rotor 53 in FIG. 24 in response to turning of key 29 causes lug 53a on the rotor to engage the primary split cam extension 55a on arm 39 and thereby rotate that arm clockwise in FIG. 25 for retracting the bolt. Rotor 53 is also rotatable by the actuator 25 at the interior side of the door, enabling unlocking of the deadbolt.

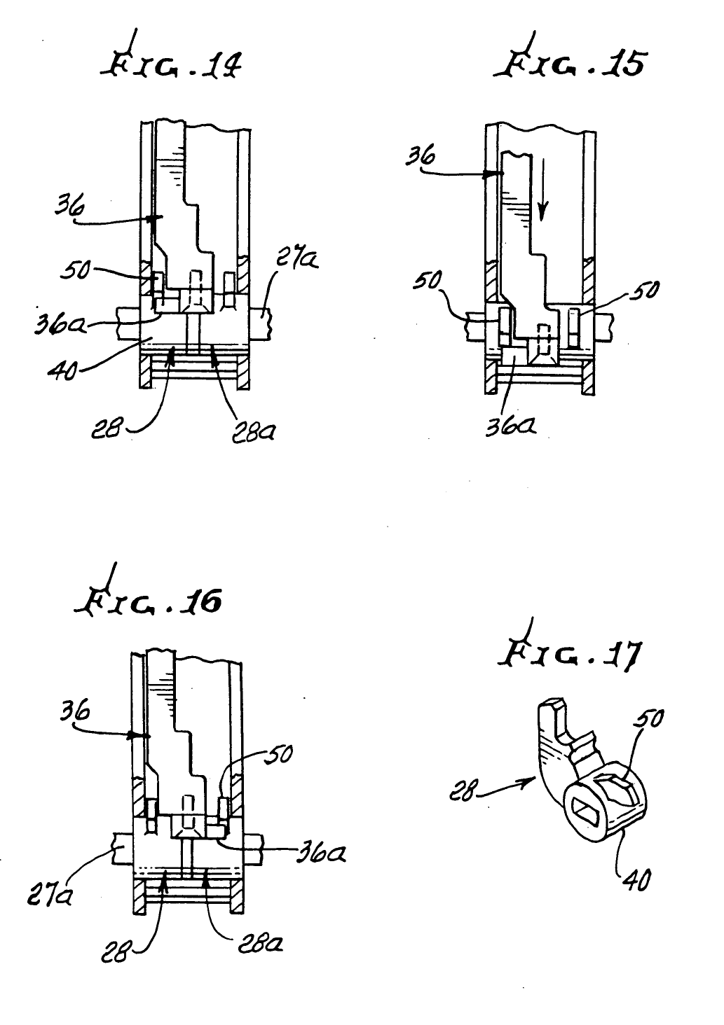

In FIGS. 5-9, and 17, and as referred to, the actuator or camming part 28 carried by rotary split hub part 40 is operable upon handle actuated rotation of 40 to rotate and engage lug 42 on the latch to push the latch into retracted position. As referred to, rotation of 28 is effected by handle 27 at the inner side of the door, which also effects deadbolt retraction, via link 36. See FIGS. 14, and 25. In addition, rotation of companion split hub part 28a by the exterior side handle 32 (see FIG. 5) effects latch retraction via rotation of actuator 28a to engage protrusion 56 on the latch, (see FIG. 8) to push the latch into retraction, but without affecting the status of the deadbolt. To retract it, the key 29 must be inserted and turned, to rotate rotor 53, as referred to.

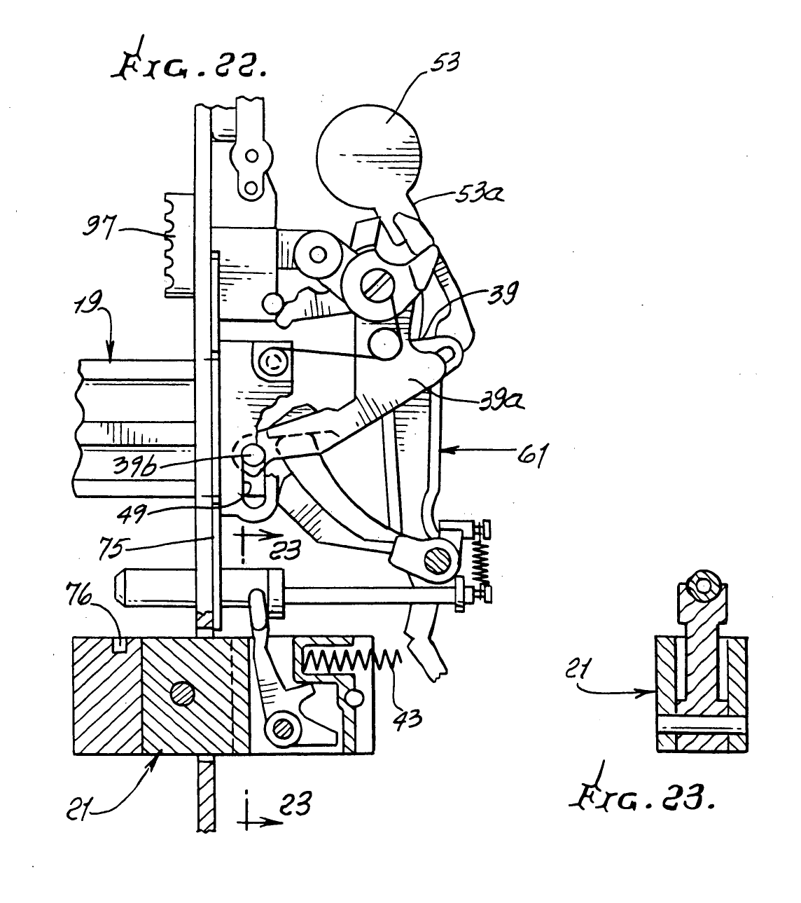

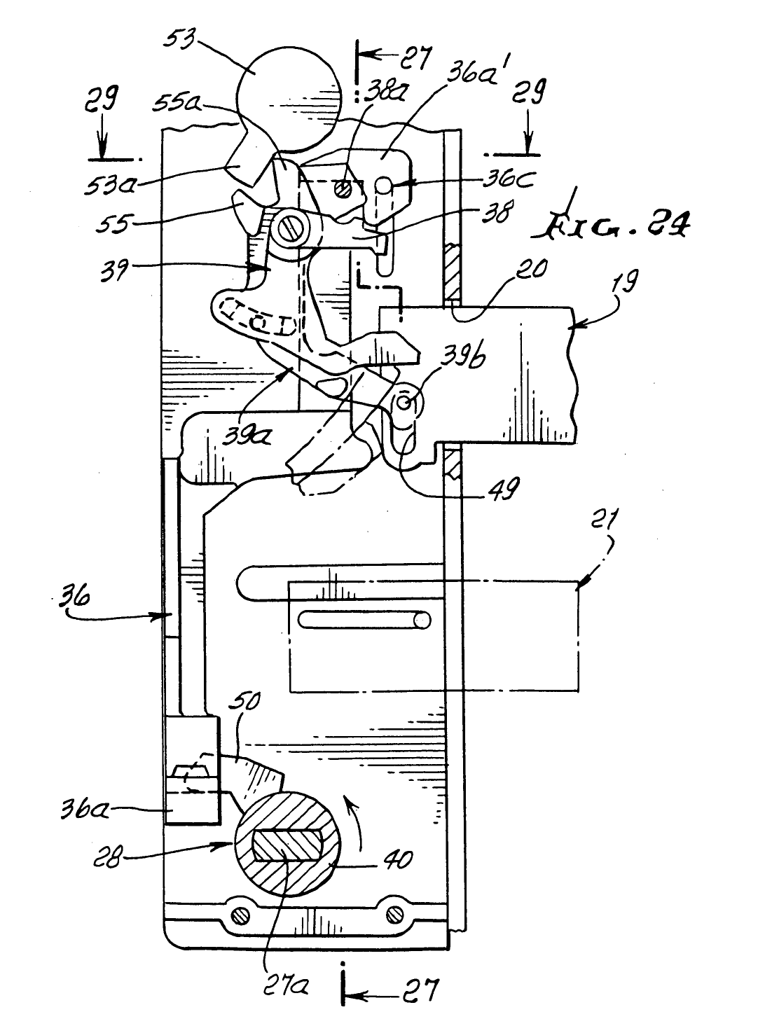

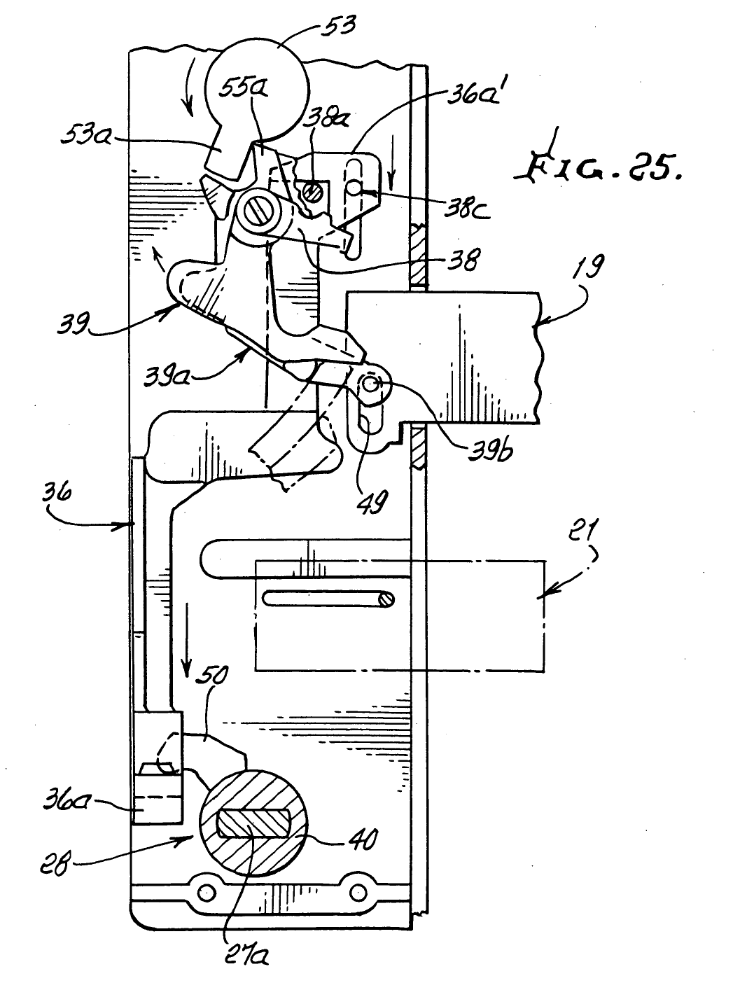

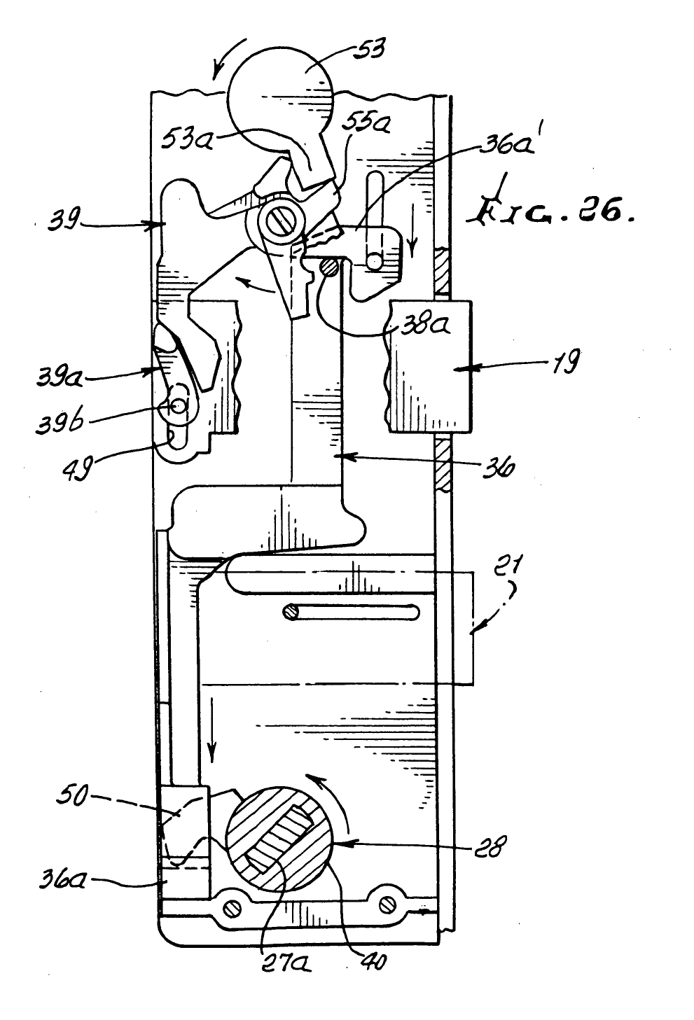

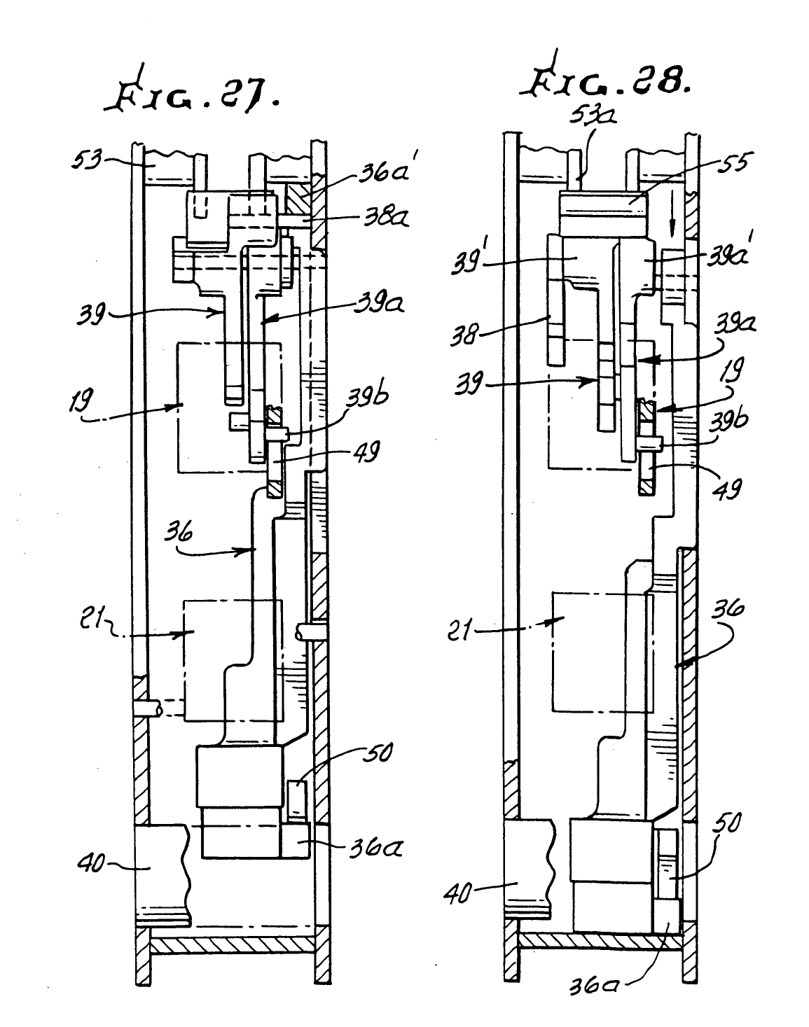

FIGS. 18-21 show the provision of hold back plate 95 movable downwardly, as seen in FIG. 20, to effect insertion of the plate lower tip portion 95a into a groove 76 in the top of the latch 21. This holds the latch against movement into latching position. Plate 95 is carried by the frame for sliding movement. A serrated pusher 97 associated with the plate protrudes at 97a for thumb actuation, as seen in FIG. 1. A hold back plate retainer 98 is engageable by a rightwardly movable clutch 79 (see FIGS. 18 and 19) actuated by the pivotable extension 55a of the cam part 55, pivoted at 62a. When latch 61 is moved leftwardly to bring groove 76 into registration with hold back plate tip portion 95a, as by clockwise rotation of rotor 53, the latch 21 is displaced to the left, by lower extent of cam part 61, to bring groove 76 into vertical registration with hold back tip 95a, at which time the hold back is movable downwardly, allowing the teeth 99a on clutch 79 to engage teeth 98a on the retainer 78 carried by the plate 95, locking the latch in retracted position.

### SUMMARY OF USER OPERATION

1. From extension side of door, key 29 is turning to unlock (retract) the deadbolt 19. Then handle 22 is turned to retract latch 21, to open door, and also perform this function in case deadbolt was already retracted.
2. From interior side of door, rotary retractor 25 is turnable to unlock (retract) the deadbolt. Also, actuator 25 is turnable to effect retraction of latch 21, via arm 61. This enables operation of the hold back 95 and 97 to enable door to swing freely.
3. From interior side of door, handle 27 can be turned to retract both latch and the deadbolt, as in an emergency.

1. A locking system enabling selectively handed handle turning as for unlocking a door, comprising in combination:
a) drive means including said handle rotatable clockwise and counterclockwise,
b) driven means including a part movable linearly in a primary direction, to operate door lock structure,
c) and coupling means including a handle rotation direction selector having first and second alternate positions, and operable to displace said part in said primary direction in response to handle clockwise rotation when the selector is in said first position, and alternatively to displace said part in said primary direction in response to handle counterclockwise rotation when the selector is in said second position.

2. The combination of claim 1 wherein said coupling means typically include two coupling racks, one of which is operatively coupled to the driven part when the handle is rotated clockwise, and the other of which operatively coupled to the driven part when the handle is rotated counterclockwise.

3. The combination of claim 2 wherein the selector is alternatively coupled to one or the other of two coupling racks, whereby the non-coupled rack remains inactive when the coupled rack is displaced in said direction in response to handle rotation.

4. The combination of claim 3 wherein said part includes a linearly movable lock actuating member to which one or the other of the racks is coupled by said selector.

5. The combination of claim 4 wherein said selector comprises a connector shiftable between alternate positions of rack coupling to the lock actuating member, as at the time of lock system installation.

6. The combination of claim 2 wherein the racks are separately movable in parallel relation, at opposite sides of a rack engaging gear driven by handle rotation.

7. The combination of claim 4 wherein said member comprises a linearly movable plate incorporating a further rack operatively coupled to a driven gear that operates door locking and unlocking mechanism.

8. The combination of claim 7 wherein the two coupling racks, and said further rack are longitudinally vertically oriented, in compact relation.

9. A multi-function door lock system, comprising in combination:
a) a frame having opposite sides, and installable on a door openable between an interior space and an exterior space,
b) a deadbolt and a door latch carried by the frame to move between retractable and extended positions,
c) a first rotary control located at one level on the frame to control deadbolt movement between extended and retracted positions via primary cam mechanism,
d) a second rotary control at another level on the frame to control latch movement between extended and retracted positions, via secondary cam mechanism,
e) means operatively connected between said secondary cam mechanism and said primary cam mechanism to effect deadbolt movement as aforesaid in response to operation of said second rotary control, as effected via rotary input to said second rotary control from only one side of the frame.

10. The combination of claim 9 wherein said means includes a strut extending between said secondary and primary cam mechanism and bodily movable in response to said rotary input to said second rotary control.

11. The combination of claim 9 wherein said first rotary control has input means presented at opposite sides of the frame for effective operation of said first rotary control from either the door to which the frame is installed.

12. The combination of claim 9 wherein said second rotary control has input means presented at opposite sides of the frame, for effecting operation of the same second rotary control from either side of the door to which the frame is installed.

13. The combination of claim 11 wherein the second rotary control has input means presented at opposite sides of the frame, for effecting operation of the same second rotary control from either side of the door to which the frame is installed.

14. The combination of claim 9 including finger and thumb operated rotors at opposite sides of the frame and connected with said first rotary control.

15. The combination of claim 9 including handle levers operated at opposite sides of the frame and connected with said second rotary control whereby only the lever at the inner side of the frame and door operates said means, in response to turning of the lever.

16. The combination of claim 14 including handle levers operated at opposite sides of the frame and connected with said second rotary control whereby only the lever at the inner side of the frame and door operates said means, in response to turning of the lever.

17. The combination of claim 10 including first split-cam means is provided to operate in conjunction with operation of the first rotary control.

18. The combination of claim 17 including second split-cam means is provided to operate in conjunction with operation of the second rotary control and displacement of the strut.

19. The combination of claim 9 wherein:
f) said first rotary control includes a deadbolt actuating lever, and two cam followers associated with the lever to be displaced in opposite rotary directions, respectively, to displace the deadbolt between extended and retracted positions, and in response to operation of a primary cam defined by said primary cam mechanism.

20. The combination of claim 19 wherein said means includes a link having operation connection to said lever to displace that lever in a rotary direction to effect extension of the deadbolt, in response to said rotary input to said second rotary control.

21. The combination of claim 19 wherein said lever has lost motion connection to the deadbolt, and lost motion connection to said link.

22. The combination of claim 19 including an auxiliary lever pivotable to effect retraction of the latch in response to rotation of said primary cam.

23. The combination of claim 19 wherein the primary cam includes a dog extending between two of said followers for displacing the actuating lever in said respective opposite rotary direction.

24. A multi-function door lock system, comprising in combination:
a) a frame having opposite sides, and installable on a door openable between an interior space and an exterior space,
b) a deadbolt and a door latch carried by the frame to move bottom retractable and extended position,
c) a first rotary control located at one level on the frame to control deadbolt movement between extended and retracted position via primary cam mechanism,
d) a second rotary control at another level on the frame to control latch movement between extended and retracted position, via secondary cam mechanism,
e) said first rotary control including a deadbolt actuating lever, and two cam followers associated with the lever to be displaced in opposite rotary directions, respectively, to displace the deadbolt between extended and retracted positions, and in response to operation of a primary cam defined by said primary cam mechanism.

25. A multi-function door lock system, comprising in combination:
a) a frame having opposite sides, and installable on a door openable between an interior space and an exterior space,
b) a deadbolt and a door latch carried by the frame to move between retractable and extended positions,
c) a first rotary control located at one level on the frame to control deadbolt movement between extended and retracted positions via primary cam mechanism,
d) a second rotary control at another level on the frame to control latch movement between extended and retracted positions, via secondary cam mechanism,
e) and means responsive to reserve rotation of the first rotary control to effect latch retraction independently of deadbolt displacement.
